(19) United States
(12) Patent Application Publication
(10) Pub. No.: US 2025/0289432 A1
(43) Pub. Date: Sep. 18, 2025

(54) TRAVELING CONTROL DEVICE AND METHOD FOR VEHICLE

(71) Applicant: TOYOTA JIDOSHA KABUSHIKI KAISHA, Toyota-shi Aichi-ken (JP)

(72) Inventor: Kentaro KAMIJO, Susono-shi Shizuoka-ken (JP)

(73) Assignee: TOYOTA JIDOSHA KABUSHIKI KAISHA, Toyota-shi Aichi-ken (JP)

(21) Appl. No.: 19/021,446

(22) Filed: Jan. 15, 2025

(30) Foreign Application Priority Data
Mar. 13, 2024 (JP) 2024-039326

(51) Int. Cl. B60W 30/18

(52) U.S. Cl. CPC B60W 30/18154; B60W 2520/10; B60W 2720/106

(57) ABSTRACT

In a situation where a navigation device has detected first and second intersections that are located on a traveled road being traveled by a vehicle, each within a reference range from the vehicle, and that are some distance away from each other, it is determined that a deceleration permission condition is fulfilled when it is estimated that the vehicle will travel through the first intersection along the traveled road and also when a time period estimated to be required for the vehicle to arrive at the first intersection is less than a first reference value, and further in a situation where it is determined that the deceleration permission condition is fulfilled, deceleration control of causing the vehicle to decelerate is started when it is determined that a time period estimated to be required for the vehicle to arrive at the second intersection is less than a second reference value.

### CROSS-REFERENCE TO RELATED APPLICATION

This application claims priority to Japanese Patent Application No. 2024-039326 filed on Mar. 13, 2024, incorporated herein by reference in its entirety.

### BACKGROUND

### 1. Technical Field

The disclosure relates to a traveling control device for a vehicle such as an automobile and, more specifically, to a traveling control device and method for a vehicle that perform deceleration control of causing a vehicle to automatically decelerate.

### 2. Description of Related Art

As one of traveling control devices for a vehicle such as an automobile, a traveling control device has been known that assists a driver in driving when a vehicle arrives at an intersection, by performing deceleration control of causing the vehicle to automatically decelerate.

For example, the following Japanese Patent No. 6881323 (JP 6881323 B) describes a traveling control device that raises the degree of driving assistance to avoid collision when it is predicted that an own vehicle will turn right or turn left at an intersection and it is estimated that the driver of a following vehicle perceives that the own vehicle will not turn right or turn left at the intersection.

According to such a sort of traveling control device, in a situation where it is predicted that an own vehicle will turn right or turn left at an intersection, the degree of driving assistance to avoid collision can be changed depending on whether or not the driver of a following vehicle perceives that the own vehicle will not turn right or turn left at the intersection.

### SUMMARY

In conventional traveling control devices like the traveling control device described in JP 6881323 B, deceleration control in cases where a vehicle travels a road having two intersections that are some distance away from each other is not taken into consideration. When a vehicle travels a road having two intersections, deceleration through deceleration control toward the second intersection cannot be performed unless the vehicle passes the first intersection. Accordingly, deceleration toward the second intersection may be performed late in some cases, depending on the distance between the two intersections.

The present disclosure provides a traveling control device and method that are improved such that in a situation where a vehicle travels a road having two intersections that are some distance away from each other, the possibility that deceleration through deceleration control toward the second intersection is performed late is reduced, compared to conventional techniques.

According to the present disclosure, a traveling control device (100) for a vehicle is provided that includes: a deceleration device (brake control device 36) that decelerates a vehicle (102); an intersection detection device (navigation device 80) that detects an intersection ahead of the vehicle; and a control unit (driving assistance ECU 10) configured to perform deceleration control of causing the vehicle to automatically decelerate by using the deceleration device (S40, S90) when the vehicle arrives at the intersection detected by the intersection detection device.

In a situation where first and second intersections (IN1, IN2) are detected by the intersection detection device (navigation device 80) (S10, S20), the first and second intersections located on a traveled road (110) that is being traveled by the vehicle, each within a reference range from the vehicle (102), the first and second intersections being some distance away from each other, the first intersection (IN1) being nearer to the vehicle than the second intersection (IN2), the control unit (driving assistance ECU 10) is configured to determine that a deceleration permission condition is fulfilled (S60) when it is estimated that the vehicle will travel through the first intersection along the traveled road (S30) and also when a time period (T1) estimated to be required for the vehicle to arrive at the first intersection is less than a first reference value (T1c), and further in a situation where it is determined that the deceleration permission condition is fulfilled, the control unit (driving assistance ECU 10) is configured to start the deceleration control (S90) when it is determined that a time period (T2) estimated to be required for the vehicle to arrive at the second intersection is less than a second reference value (T2c).

Moreover, according to the present disclosure, a traveling control method for a vehicle is provided that includes: detecting an intersection ahead of a vehicle (102) (S10, S20); and performing deceleration control of causing the vehicle to automatically decelerate by using a deceleration device (S40, S90) when the vehicle arrives at the detected intersection.

The traveling control method further includes: in a situation where first and second intersections (IN1, IN2) are detected (S10, S20), the first and second intersections located on a traveled road (110) that is being traveled by the vehicle, each within a reference range from the vehicle (102), the first and second intersections being some distance away from each other, the first intersection (IN1) being nearer to the vehicle than the second intersection (IN2), determining that a deceleration permission condition is fulfilled (S60) when it is estimated that the vehicle will travel through the first intersection along the traveled road (S30) and also when a time period (T1) estimated to be required for the vehicle to arrive at the first intersection is less than a first reference value (T1c); and in a situation where it is determined that the deceleration permission condition is fulfilled, starting the deceleration control (S90) when it is determined that a time period (T2) estimated to be required for the vehicle to arrive at the second intersection is less than a second reference value (T2c).

According to the traveling control device and method, it is determined that the deceleration permission condition is fulfilled when it is estimated that the vehicle will travel through the first intersection along the traveled road and also when the time period estimated to be required for the vehicle to arrive at the first intersection is less than the first reference value. Accordingly, before the vehicle arrives at the first intersection, it can be determined whether or not the deceleration permission condition is fulfilled.

Moreover, in the situation where it is determined that the deceleration permission condition is fulfilled, the deceleration control is started when it is determined that the time period estimated to be required for the vehicle to arrive at the second intersection is less than the second reference value. Accordingly, the possibility that deceleration through the deceleration control toward the second intersection is performed late can be reduced, compared to conventional traveling control devices that cannot perform deceleration through deceleration control toward the second intersection unless the vehicle passes the first intersection.

In one aspect of the present disclosure, in the situation where it is determined that the deceleration permission condition is fulfilled, the control unit (driving assistance ECU 10) may be configured to start the deceleration control (S90) when it is estimated that the vehicle (102) will not travel through the second intersection (IN2) along the traveled road (110) (S70) and also when it is determined that the time period (T2) estimated to be required for the vehicle to arrive at the second intersection is less than the second reference value (T2c) (S80).

In another aspect of the present disclosure, the control unit (driving assistance ECU 10) may be configured to estimate that the vehicle will travel through the first intersection along the traveled road (S30) when it is determined that a driver has no intention of changing the direction of the vehicle in such a manner as to turn off the traveled road (110) at the first intersection (IN1).

Further, in another aspect of the present disclosure, the control unit (driving assistance ECU 10) may be configured to acquire information on the velocity (Vp) of the vehicle and calculate the first reference value (T1c) as a value obtained by dividing the velocity by a preset constant (Gb) (S50).

Note that in the present application, an “intersection” is a part where two or more roads intersect, and specifically refers to a crossroads, a T-intersection, a Y-intersection (a fork, a junction), or a part where three or more roads intersect. A “traveled road” refers to a road that is being traveled by an own vehicle.

In the description above, to help understand the present disclosure, names and/or signs used in an embodiment, which will be described later, are attached in parentheses to components of the disclosure that correspond to those in the embodiment. However, each constituent element of the present disclosure is not limited to a constituent element in the embodiment corresponding to the name and/or the sign attached in parentheses. Other objects, other characteristics, and accompanying advantages of the present disclosure will be easily understood from a description of an embodiment of the present disclosure given with reference to the following drawings.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram showing an embodiment of a traveling control device for a vehicle according to the present disclosure;

FIG. 2 is a flowchart corresponding to a traveling control program in the embodiment;

FIG. 3 shows a case where at first and second intersections, roads intersecting with a traveled road are a non-main road and a main road, respectively, and the vehicle does not turn right or left at the first intersection;

FIG. 4 shows a case where at the first and second intersections, roads intersecting with the traveled road are a non-main road and a main road, respectively, and the vehicle turns right or left at the first intersection;

FIG. 5 shows a case where at the first and second intersections, roads intersecting with the traveled road are a main road and a non-main road, respectively, and the vehicle does not turn right or left at the first intersection; and

FIG. 6 shows a case where at the first and second intersections, roads intersecting with the traveled road are non-main roads, and the vehicle does not turn right or left at the first and second intersections.

### DETAILED DESCRIPTION OF EMBODIMENTS

Hereinafter, a traveling control device according to an embodiment of the present disclosure is described in detail with reference to the accompanying drawings.

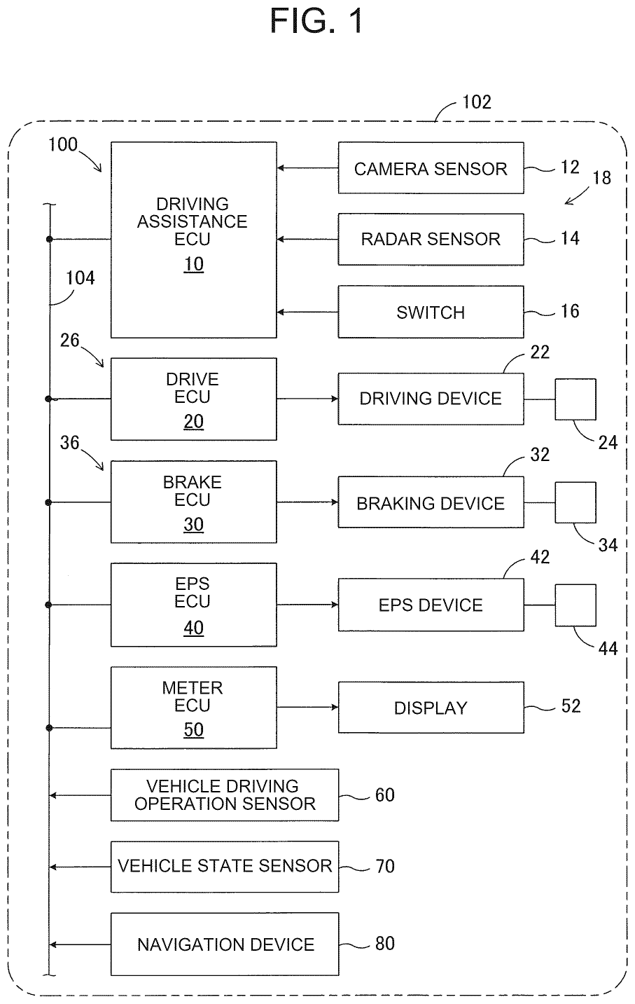

As shown in FIG. 1, the traveling control device 100 according to the embodiment of the present disclosure is applied to a vehicle 102 and includes a driving assistance ECU 10. The vehicle 102 is a vehicle that is capable of autonomous driving, and includes a drive ECU 20, a brake ECU 30, an EPS ECU 40, and a meter ECU 50. An ECU means an electronic control unit including a microcomputer as a main part.

The microcomputer of each ECU includes a CPU, a ROM, a RAM, a readable-writable non-volatile memory (N/M), an interface (I/F), and the like. The CPU implements various functions by executing instructions (programs, routines) stored in the ROM. Further, the ECUs are connected to each other through a controller area network (CAN) 104 in such a manner as to be able to exchange data (be able to communicate). Accordingly, a detection value and the like of a sensor (including a switch) connected to a specific ECU can be transmitted also to another ECU.

The driving assistance ECU 10 is a central control device that performs control for driving assistance, such as traveling control including automatic deceleration, adaptive cruise control, and lane keeping control. In the embodiment, the driving assistance ECU 10, in cooperation with the other ECUs, performs traveling control for the vehicle 102, which will be described in detail later. In the embodiment, the driving assistance ECU 10 performs traveling control including deceleration control of causing the vehicle to automatically decrease velocity when the vehicle arrives at an intersection existing ahead.

A camera sensor 12, a radar sensor 14, and setting operation equipment 16 are connected to the driving assistance ECU 10. The camera sensor 12 and the radar sensor 14 include a plurality of camera devices and a plurality of radar devices, respectively. The camera sensor 12 and the radar sensor 14 function as a target information acquisition device 18 that acquires information on a target around the vehicle 102.

Each camera device of the camera sensor 12 includes a camera section and a recognition section, neither of which are depicted. The camera section captures an image of surroundings of the vehicle 102, and the recognition section analyzes image data acquired by the camera section capturing an image and recognizes a target such as a white line on a road, another vehicle, or the like. The recognition section supplies information related to the recognized target to the driving assistance ECU 10 in each predetermined period.

Each radar device of the radar sensor 14 detects the distance between the own vehicle and a three-dimensional object, the velocities of the own vehicle and the three-dimensional object relative to the respective others, the position (direction) of the three-dimensional object relative to the own vehicle, and the like by using radio waves in a millimeter band, and supplies information indicating such distance, relative velocities, relative position, and the like to the driving assistance ECU 10 in each predetermined period. Note that a light detection and ranging (LiDAR) may be used in place of, or in addition to, the radar sensor 14.

The setting operation equipment 16 is provided at a position, such as a steering wheel, which is not depicted in FIG. 1, where the setting operation equipment 16 can be operated by a driver, and is configured to be operated by the driver. The setting operation equipment 16 includes a driving assistance switch, which is not depicted in FIG. 1. The driving assistance ECU 10 performs traveling control when the driving assistance switch is on, which will be described in detail later.

A driving device 22 that accelerates the vehicle 102 by applying driving force to a driving wheel 24 is connected to the drive ECU 20. The drive ECU 20, at normal times, controls the driving device 22 in such a manner that the driving force generated by the driving device 22 changes according to drive operations by the driver and, when a command signal is received from the driving assistance ECU 10, controls the driving device 22 based on the command signal. Accordingly, the drive ECU 20 and the driving device 22 function as a drive control device 26 in cooperation with each other.

A braking device 32 that decelerates the vehicle 102 through braking by applying braking force to a wheel 34 is connected to the brake ECU 30. The brake ECU 30, at normal times, controls the braking device in such a manner that the braking force generated by the braking device 32 changes according to braking operations by the driver and, when a command signal is received from the driving assistance ECU 10, performs automatic braking by controlling the braking device 32 based on the command signal.

Accordingly, the brake ECU 30 and the braking device 32 function as a brake control device 36 in cooperation with each other. The brake control device 36, in cooperation with the drive control device 26, functions as a deceleration device that decelerates the vehicle 102. Note that when braking force is applied to wheels through traveling control or the like, a stop lamp, which is not depicted in FIG. 1, is turned on.

An EPS device 42 is connected to the EPS ECU 40. The EPS ECU 40 controls steering assist torque by controlling the EPS device 42, based on steering torque and velocity, in a manner that is publicly known in the relevant technical field, and thereby reduces a steering burden on the driver. Moreover, the EPS ECU 40 can turn a steering wheel 44 when necessary by controlling the EPS device 42.

A touch-panel display 52 that displays a situation of the control by the driving assistance ECU 10 and the like is connected to the meter ECU 50. For example, the display 52 may be a multi-information display on which meters and various information are displayed, or may be a display of a navigation device 80, which will be described later. When a signal is received from the driving assistance ECU 10, the display 52 displays a situation of traveling control, which will be described later.

A vehicle driving operation sensor 60 and a vehicle state sensor 70 are also connected to the CAN 104. Information (referred to as sensor information) detected by the vehicle driving operation sensor 60 and the vehicle state sensor 70 is transmitted to the CAN 104. The sensor information transmitted to the CAN 104 can be used by each ECU as appropriate. Note that the sensor information may be information from a sensor connected to a specific ECU and may be transmitted to the CAN 104 from the specific ECU.

The vehicle driving operation sensor 60 includes a drive operation amount sensor that detects an accelerator pedal operation amount, a brake operation amount sensor that detects master cylinder pressure or brake pedal force, and a brake switch that detects whether or not operation of a brake pedal is performed. Moreover, the vehicle driving operation sensor 60 includes a steering angle sensor that detects a steering angle, a steering torque sensor that detects steering torque, a turn signal lamp switch that indicates whether or not operation of a turn signal lamp lever is performed and the direction of the operation, and the like.

The vehicle state sensor 70 includes a velocity sensor that detects the velocity V of the vehicle 102, a front-rear acceleration degree sensor that detects an acceleration degree in the front-rear direction of the vehicle, a lateral acceleration degree sensor that detects an acceleration degree in the lateral direction of the vehicle, a yaw rate sensor that detects the yaw rate of the vehicle, and the like.

Further, the navigation device 80 is also connected to the CAN 104. The navigation device 80 includes a GPS receiver that detects the position of the vehicle 102, a storage device that stores map information and road information, and a communication device that externally acquires the latest information of the map information and the road information. The road information, in particular, includes information on intersections and information on whether or not a road is a main road, and the navigation device 80 functions as an intersection detection device that detects an intersection existing ahead of the vehicle.

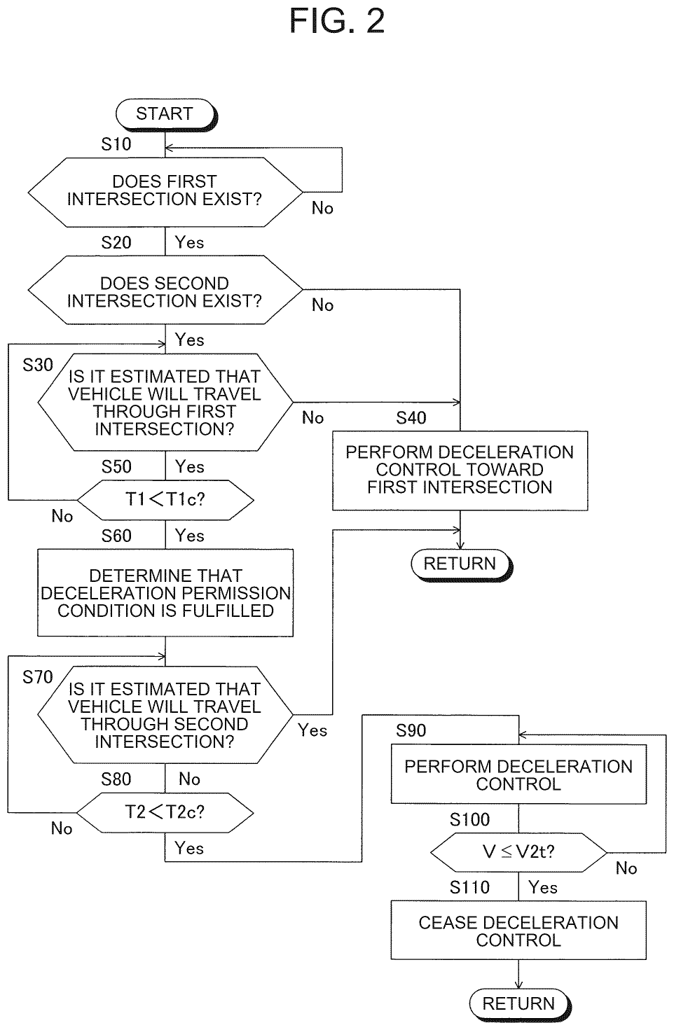

In the embodiment, the ROM of the driving assistance ECU 10 stores a traveling control program that corresponds to a flowchart shown in FIG. 2. A traveling control method according to the embodiment is executed by traveling control being performed according to the flowchart shown in FIG. 2.

### Traveling Control (FIG. 2)

Next, the traveling control in the embodiment is described with reference to the flowchart shown in FIG. 2. The traveling control according to the flowchart shown in FIG. 2 is performed by the CPU of the driving assistance ECU 10 in each predetermined period in a repeated manner, in a situation where the driving assistance switch is on. Note that when a braking operation is performed by the driver while the traveling control is being performed, the traveling control is terminated such that deceleration through the braking operation is more prioritized than deceleration through the traveling control, and deceleration of the vehicle is left to the braking operation by the driver.

First, in step S10, the CPU determines whether or not a first (first appearing) intersection that is located ahead on a traveled road on which the vehicle is traveling within a first reference range L1r (a positive constant) from the vehicle 102 has been detected by the navigation device 80 functioning as an intersection detection device. When a negative determination is made, the present control is terminated once, and an affirmative determination is made, the present control moves to step S20.

In step S20, the CPU determines whether or not a second (second appearing) intersection that is located ahead on the traveled road within a second reference range L2r (a positive constant that is larger than the first range L1r) from the vehicle 102 and is some distance away from the first intersection in a forward direction has been detected by the navigation device 80. When a negative determination is made, the present control moves to step S40, and an affirmative determination is made, the present control moves to step S30.

In step S30, the CPU determines whether or not it is estimated that the vehicle 102 will travel through the first intersection along the traveled road. When an affirmative determination is made, the present control moves to step S50, and a negative determination is made, the present control moves to step S40.

In step S30, a negative determination is made (1) when the turn signal lamp switch is in a right-turn position or a left-turn position, or (2) when the vehicle is in a right-turn lane or a left-turn lane, that is, when it is estimated that the driver has an intention of changing the direction of the vehicle in such a manner as to turn off the traveled road. Note that as to (2), determination may be performed based on target information acquired by the target information acquisition device 18. Moreover, a negative determination is also made (3) when a traffic light on the traveled road side at the first intersection is red or yellow. In contrast, an affirmative determination may be made when none of the conditions (1) to (3) are fulfilled, and more particularly, an affirmative determination may be made when none of the conditions (1) to (3) are fulfilled and also when a road intersecting with the traveled road at the first intersection is not a main road.

In step S40, the CPU acquires information on a distance L1 from the current position of the vehicle 102 to the first intersection, based on information from the navigation device 80 or information acquired by the target information acquisition device 18. Further, the CPU performs deceleration control of causing the vehicle to decelerate toward the first intersection, by setting a target deceleration pattern in a manner publicly known in the relevant technical field, based on the current velocity Vp of the vehicle 102, a target velocity V1t at a time the vehicle 102 arrives at the first intersection, and the distance L1, and controlling the brake control device 36 according to the target deceleration pattern.

Accordingly, the velocity V of the vehicle 102 is controlled through the deceleration control such that the velocity at the time the vehicle arrives at the first intersection becomes the target velocity V1t. Note that although the target velocity V1t may be a preset constant, the target velocity V1t may be variably set based on the type of the first intersection, a situation of a traffic light, or the like, and may be zero when the traffic light is red or yellow.

For example, when the intersection is a T-intersection and the traveled road is a road coming, at the end thereof, to a straight road, or when the intersection is a junction and the traveled road is a road joining a main road, the target velocity V1t may be a lower value than when the intersection is a crossroads.

In step S50, the CPU calculates a time period T1 estimated to be required for the vehicle to arrive at the first intersection, based on the distance L1 from the current position of the vehicle 102 to the first intersection and the current velocity Vp of the vehicle. Further, the CPU determines whether or not the time period T1 is less than a first reference-value time period T1c. When a negative determination is made, the present control returns to step S30, and when an affirmative determination is made, the present control moves to step S60.

Note that the first reference-value time period T1c may be a positive constant set as a duration for which a driver having a general driving technique continues decelerating a vehicle before an intersection. However, in the embodiment, the first reference-value time period T1c is calculated as Vp/Gb where Gb [m/sec²] is a degree of deceleration when a driver having a general driving technique decelerates a vehicle before an intersection, and Vp [m/sec] is the current velocity of the vehicle.

In step S60, the CPU determines that a deceleration permission condition is fulfilled because it is estimated that the vehicle will travel through the first intersection along the traveled road and it is determined that the time period T1 estimated to be required for the vehicle to arrive at the first intersection is less than the first reference value T1c.

In step S70, as in step S30, the CPU determines whether or not it is estimated that the vehicle 102 will travel through the second intersection along the traveled road. When an affirmative determination is made, the present control is terminated once, and when a negative determination is made, the present control moves to step S80.

In step S70 as well, a negative determination is made (1) when the turn signal lamp switch is in the right-turn position or the left-turn position, or (2) when the vehicle 102 is in a right-turn lane or a left-turn lane. A negative determination is also made (3) when a traffic light on the traveled road side at the second intersection is red or yellow. In contrast, an affirmative determination may be made when none of the conditions (1) to (3) are fulfilled, and more particularly, an affirmative determination may be made when none of the conditions (1) to (3) are fulfilled and also when a road intersecting with the traveled road at the second intersection is not a main road.

In step S80, the CPU acquires information on a distance L2 from the current position of the vehicle 102 to the second intersection, based on information from the navigation device 80 or information acquired by the target information acquisition device 18. Moreover, the CPU calculates a time period T2 estimated to be required for the vehicle to arrive at the second intersection, based on the distance L2 from the current position of the vehicle 102 to the second intersection and the current velocity Vp of the vehicle. Further, the CPU determines whether or not the time period T2 is less than a second reference-value time period T2c. When a negative determination is made, the present control returns to step S70, and when an affirmative determination is made, the present control moves to step S90.

Note that the second reference-value time period T2c, similarly to the first reference-value time period T1c, is calculated as Vp/Gb, although the second reference-value time period T2c may be a positive constant set as a duration for which a driver having a general driving technique continues decelerating a vehicle before an intersection.

In step S90, the CPU acquires information on the distance L2 from the current position of the vehicle 102 to the second intersection, based on information from the navigation device 80 or information acquired by the target information acquisition device 18. Further, the CPU performs deceleration control of causing the vehicle to decelerate toward the second intersection, by setting a target deceleration pattern in a manner publicly known in the relevant technical field, based on the current velocity Vp of the vehicle 102, a target velocity V2t, and the distance L2, and controlling the brake control device 36 according to the target deceleration pattern. Note that similarly to the target velocity V1t, although the target velocity V2t may be a preset constant, the target velocity V2t may be variably set based on the type of the second intersection, a situation of a traffic light, or the like, and may be zero when the traffic light is red or yellow.

In step S100, the CPU determines whether or not the velocity of the vehicle 102 decreases to the target velocity V2t or less. When a negative determination is made, the present control returns to step S90, and when an affirmative determination is made, the present control moves to step S110.

In step S110, the CPU ceases the deceleration control by outputting a command signal to cease the deceleration control to the brake control device 36, and terminates the present control once. Accordingly, the velocity V at a time the vehicle 102 arrives at the second intersection is controlled to be equal to or less than the target velocity V2t.

### Operation of Embodiment

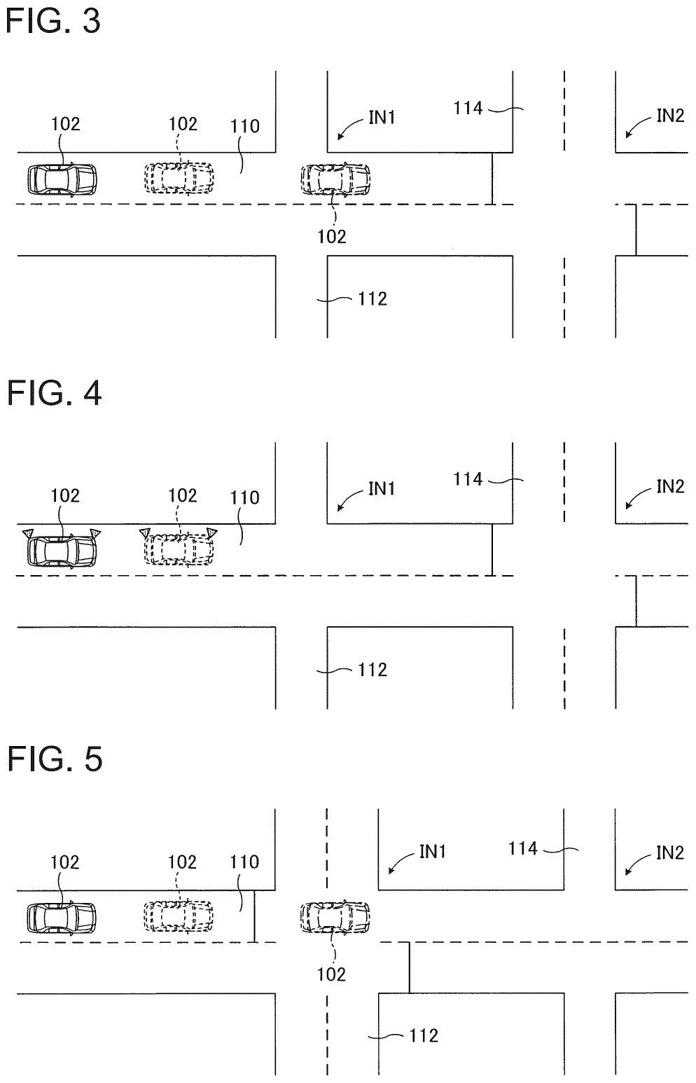

Next, operation of the embodiment in various cases where the types of the first and second intersections are varied is described with reference to FIGS. 3 to 6. Note that as shown in FIGS. 3 to 6, the vehicle 102 travels a traveled road 110, and a first intersection IN1 and a second intersection IN2 that are some distance away from each other exist on the traveled road. The first intersection IN1 and the second intersection IN2 are located within the first reference range L1r (a positive constant) and the second reference range L2r from the vehicle 102, respectively, and the first intersection is nearer to the vehicle than the second intersection. Moreover, the first intersection IN1 and the second intersection IN2 are crossroads in FIGS. 3 to 6, but may be other intersections than crossroads, such as T-intersections or Y-intersections.

### C1: Case where Roads Intersecting with Traveled Road at First and Second Intersections are Non-Main Road and Main Road, Respectively, and Vehicle Does Not Turn Right or Left at First Intersection (FIG. 3)

A road 112 intersecting with the traveled road 110 at the first intersection IN1 is a non-main road, and a road 114 intersecting with the traveled road 110 at the second intersection IN2 is a main road. It is estimated that the vehicle 102 will not turn right or left at the first intersection IN1 and will travel through the first intersection.

Affirmative determinations are made in steps S10 and S20, and an affirmative determination is made in step S30 when none of the conditions (1) to (3) are fulfilled. The vehicle 102 approaches the first intersection IN1 as indicated by a dotted line, and when it is determined that the time period T1 estimated to be required for the vehicle to arrive at the first intersection is less than the first reference-value time period T1c, an affirmative determination is made in step S50. Accordingly, before the vehicle 102 travels through the first intersection IN1, it is determined that the deceleration permission condition is fulfilled.

In the situation where the deceleration permission condition is fulfilled, when at least one of the conditions (1) to (3) is fulfilled, a negative determination is made in step S70. The vehicle 102 further travels and approaches the second intersection IN2 as indicated by a dash-dotted line, and when it is determined that the time period T2 estimated to be required for the vehicle to arrive at the second intersection is less than the second reference-value time period T2c, an affirmative determination is made in step S80. Accordingly, the deceleration control through steps S90 to S110 is performed, whereby the velocity V at a time the vehicle 102 arrives at the second intersection IN2 is controlled to be equal to or less than the target velocity V2t.

Note that although the road intersecting at the second intersection IN2 is a main road in FIG. 3, also in a case where the road intersecting at the second intersection is a non-main road, a negative determination is made in step S70 when at least one of the conditions (1) to (3) is fulfilled. When none of the conditions (1) to (3) are fulfilled and an affirmative determination is made in step S70, the deceleration control is not performed because steps S90 to S110 are not executed.

### C2: Case where Roads Intersecting with Traveled Road at First and Second Intersections are Non-Main Road and Main Road, Respectively, and Vehicle Turns Right or Left at First Intersection (FIG. 4)

As in the case C1, the road 112 intersecting with the traveled road 110 at the first intersection IN1 is a non-main road, and the road 114 intersecting with the traveled road 110 at the second intersection IN2 is a main road. However, it is estimated that the vehicle 102 will turn right or turn left at the first intersection IN1.

Affirmative determinations are made in steps S10 and S20, but a negative determination is made in step S30. Accordingly, in step S40, the deceleration control of causing the vehicle 102 to decelerate toward the first intersection IN1 is performed, and the velocity V of the vehicle is controlled in such a manner that the velocity at a time the vehicle arrives at the first intersection becomes the target velocity V1t.

### C3: Case where Roads Intersecting with Traveled Road at First and Second Intersections are Main Road and Non-Main Road, Respectively, and Vehicle Does Not Turn Right or Left at First Intersection (FIG. 5)

The road 112 intersecting with the traveled road 110 at the first intersection IN1 is a main road, and the road 114 intersecting with the traveled road 110 at the second intersection IN2 is a non-main road. It is estimated that the vehicle 102 will not turn right or left at the first intersection IN1 and will travel through the first intersection.

As in the case C1, affirmative determinations are made in steps S10 and S20, and an affirmative determination is made in step S30 when none of the conditions (1) to (3) are fulfilled. Accordingly, before the vehicle 102 travels through the first intersection IN1, it is determined that the deceleration permission condition is fulfilled.

In the situation where the deceleration permission condition is fulfilled, when at least one of the conditions (1) to (3) is fulfilled, a negative determination is made in step S70. Accordingly, the deceleration control through steps S90 to S110 is performed, whereby the velocity V at a time the vehicle 102 arrives at the second intersection IN2 is controlled to be equal to or less than the target velocity V2t.

Note that although the road intersecting at the second intersection IN2 is a non-main road in FIG. 5, also in a case where the road intersecting at the second intersection is a main road, a negative determination is made in step S70 when at least one of the conditions (1) to (3) is fulfilled. When none of the conditions (1) to (3) are fulfilled and an affirmative determination is made in step S70, the deceleration control is not performed because steps S90 to S110 are not executed.

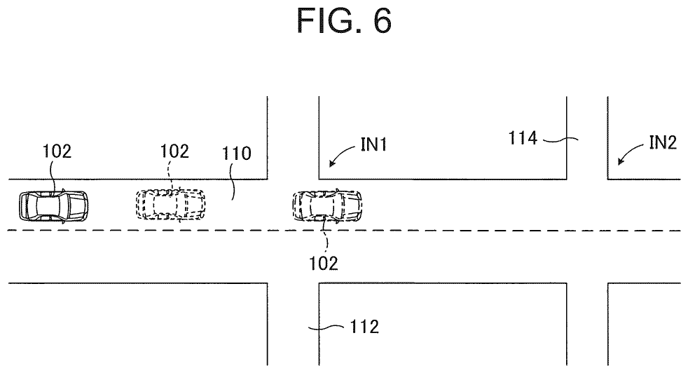

### C4: Case where Roads Intersecting with Traveled Road at First and Second Intersections are Non-Main Roads, and Vehicle Does Not Turn Right or Left at First and Second Intersections (FIG. 6)

The roads 112 and 114 intersecting with the traveled road 110 at the first intersection IN1 and the second intersection IN2, respectively, are non-main roads. It is estimated that the vehicle 102 will not turn right or left at the first intersection IN1 and the second intersection IN2 and will travel through the first and second intersections.

Affirmative determinations are made in steps S10 and S20, and when none of the conditions (1) to (3) are fulfilled, it is estimated that the vehicle will travel through the first and second intersections, and affirmative determinations are made in steps S30 and S70. Since steps S40 and S90 to S110 are not executed, the deceleration control is not performed.

Note that in a situation where the vehicle 102 approaches the first intersection, when any of the conditions (1) to (3) is fulfilled and a negative determination is made in step S30, step S40 is executed. Accordingly, as in the case C2, the deceleration control of causing the vehicle 102 to decelerate toward the first intersection IN1 is performed, and the velocity V of the vehicle is controlled in such a manner that the velocity at a time the vehicle arrives at the first intersection becomes the target velocity V1t.

Moreover, after affirmative determinations are made in steps S30 and S50, when none of the conditions (1) to (3) are fulfilled and a negative determination is made in step S70, step S80 is executed. Further, when an affirmative determination is made in step S80, the deceleration control through steps S90 to S110 is performed. Accordingly, as in the case C1, the velocity V at a time the vehicle 102 arrives at the second intersection IN2 is controlled to be equal to or less than the target velocity V2t.

As can be understood from the description above, according to the present disclosure, when it is estimated that the vehicle 102 will travel through the first intersection IN1 along the traveled road 110 (S30), and also when the time period T1 estimated to be required for the vehicle to arrive at the first intersection is less than the first reference value T1c (S50), it is determined that the deceleration permission condition is fulfilled (S60). Accordingly, before the vehicle arrives at the first intersection, it can be determined whether or not the deceleration permission condition is fulfilled.

Moreover, in the situation where the deceleration permission condition is fulfilled, when it is determined that the time period T2 estimated to be required for the vehicle to arrive at the second intersection IN2 is less than the second reference value T2c (S80), the deceleration control is started (S90). Accordingly, the possibility that deceleration through the deceleration control toward the second intersection is performed late can be reduced, compared to conventional traveling control devices that cannot perform deceleration through deceleration control toward the second intersection unless the vehicle passes the first intersection.

Moreover, according to the present disclosure, when it is estimated that the vehicle 102 will not travel through the second intersection IN2 along the traveled road 110 (S70), and also when it is determined that the time period T2 estimated to be required for the vehicle to arrive at the second intersection is less than the second reference value T2c (S80), the deceleration control is started (S90). Accordingly, the possibility that the deceleration control is unnecessarily performed can be reduced, compared to a case where the estimation that the vehicle will not travel through the second intersection along the traveled road is not used for a requirement for start of the deceleration control.

Further, according to the present disclosure, when it is determined that the driver has no intention of changing the direction of the vehicle in such a manner as to turn off the traveled road 110 at the first intersection IN1, it is estimated that the vehicle will travel through the first intersection along the traveled road (S30). Accordingly, by determining whether or not the driver has an intention of changing the direction of the vehicle in such a manner as to turn off the traveled road at the first intersection, it can be estimated whether or not the vehicle will travel through the first intersection along the traveled road.

Furthermore, according to the present disclosure, the first reference value T1c is calculated as a value obtained by dividing the velocity V by the preset constant (S50).

Accordingly, the first reference value is variably set according to the velocity in such a manner that the higher the velocity is, the larger the first reference value is. Accordingly, a timing of start of the deceleration control can be appropriately determined, compared to a case where the first reference value is constant, irrespective of the velocity.

According to the embodiment in particular, the preset constant is a degree of deceleration Gb demonstrated when a driver having a general driving technique decelerates a vehicle before an intersection. Accordingly, the first reference value can be set as a duration for which a driver having a general driving technique continues decelerating a vehicle before an intersection.

Although a specific embodiment of the present disclosure has been described in detail hereinabove, the present disclosure is not limited to the embodiment described above, and it would be clear to those skilled in the art that other various embodiments are feasible within the scope of the present disclosure.

For example, in the embodiment, the first reference range L1r used in the determination in step S10 and the second reference range L2r used in the determination in step S20 are positive constants. However, the reference ranges L1r and L2r may be variably set according to the velocity, for example, in such a manner that the higher the velocity Vis, the larger the reference ranges L1r and L2r are.

In the embodiment, when none of the conditions (1) to (3) are fulfilled, affirmative determinations are made in steps S30 and S70 to determine that the vehicle will travel through the first and second intersections, respectively. However, any of the conditions (1) to (3) may be omitted. Determination of whether or not a road intersecting with the traveled road at each intersection is a main road may also be omitted.

In the embodiment, the deceleration control of causing the vehicle to decelerate according to the target deceleration pattern, which is set based on the current velocity Vp of the vehicle 102, the target velocity V1t, V2t, and the distance L1, L2, is performed in steps S40 and S90. However, the deceleration control of causing the vehicle to decelerate toward the first or second intersection does not constitute the gist of the present disclosure, and may be performed in any manner publicly known in the relevant technical field.

Furthermore, in the embodiment, an affirmative determination is made in step S20 when the second intersection is detected that is located ahead on the traveled road within the second reference range from the vehicle 102 and is some distance away from the first intersection in the forward direction. In other words, the distance between the first and the second intersections can be any distance. However, when the distance between the first and second intersections is more than a reference distance, a negative determination may be made in step S20, in which case the reference distance may be variably set according to the velocity, for example, in such a manner that the higher the velocity V is, the larger the reference distance is.

What is claimed is:

1. A traveling control device for a vehicle, comprising:
a deceleration device that decelerates a vehicle;
an intersection detection device that detects an intersection ahead of the vehicle; and
a control unit configured to perform deceleration control of causing the vehicle to automatically decelerate by using the deceleration device when the vehicle arrives at the intersection detected by the intersection detection device, wherein in a situation where first and second intersections are detected by the intersection detection device, the first and second intersections located on a traveled road that is being traveled by the vehicle, each within a reference range from the vehicle, the first and second intersections being some distance away from each other, the first intersection being nearer to the vehicle than the second intersection, the control unit is configured to determine that a deceleration permission condition is fulfilled when it is estimated that the vehicle will travel through the first intersection along the traveled road and also when a time period estimated to be required for the vehicle to arrive at the first intersection is less than a first reference value, and further in a situation where it is determined that the deceleration permission condition is fulfilled, the control unit is configured to start the deceleration control when it is determined that a time period estimated to be required for the vehicle to arrive at the second intersection is less than a second reference value.

2. The traveling control device for a vehicle according to claim 1, wherein in the situation where it is determined that the deceleration permission condition is fulfilled, the control unit is configured to start the deceleration control when it is estimated that the vehicle will not travel through the second intersection along the traveled road and also when it is determined that the time period estimated to be required for the vehicle to arrive at the second intersection is less than the second reference value.

3. The traveling control device for a vehicle according to claim 1, wherein the control unit is configured to estimate that the vehicle will travel through the first intersection along the traveled road when it is determined that a driver has no intention of changing a direction of the vehicle in such a manner as to turn off the traveled road at the first intersection.

4. The traveling control device for a vehicle according to claim 1, wherein the control unit is configured to acquire information on a velocity of the vehicle and calculate the first reference value as a value obtained by dividing the velocity by a preset constant.

5. A traveling control method for a vehicle, comprising:
detecting an intersection ahead of a vehicle; and
performing deceleration control of causing the vehicle to automatically decelerate by using a deceleration device when the vehicle arrives at the detected intersection,
wherein the traveling control method further includes
in a situation where first and second intersections are detected, the first and second intersections located on a traveled road that is being traveled by the vehicle, each within a reference range from the vehicle, the first and second intersections being some distance away from each other, the first intersection being nearer to the vehicle than the second intersection, determining that a deceleration permission condition is fulfilled when it is estimated that the vehicle will travel through the first intersection along the traveled road and also when a time period estimated to be required for the vehicle to arrive at the first intersection is less than a first reference value, and
in a situation where it is determined that the deceleration permission condition is fulfilled, starting the deceleration control when it is determined that a time period estimated to be required for the vehicle to arrive at the second intersection is less than a second reference value.
